(19) United States
(12) Patent Application Publication
(10) Pub. No.: US 2024/0228758 A1
(43) Pub. Date: Jul. 11, 2024

(54) METALLOCENE POLYETHYLENE BLENDS FOR IMPROVEMENT OF ISBM PROCESS

(71) Applicant: Braskem S.A., Camaçari (BR)

(72) Inventors: Marcelo Farah, São Paulo (BR); Paulo Lourenço Brito Herrmann, São Paulo (BR); Augusto Cesar Esteves, São Paulo (BR)

(73) Assignee: Braskem S.A., Camaçari (BR)

(21) Appl. No.: 18/396,849

(22) Filed: Dec. 27, 2023

Related U.S. Application Data
(60) Provisional application No. 63/435,826, filed on Dec. 29, 2022.

(51) Int. Cl. C08L 23/08; B29C 45/00; B29K 23/00; C08F 210/08

(52) U.S. Cl. CPC C08L 23/0815; B29C 45/0001; B29C 45/0055; C08F 210/08; B29K 2023/065; C08L 2205/025; C08L 2207/062; C08L 2207/066; C08L 2314/06

(57) ABSTRACT

A polyethylene-based resin composition for injection stretch blow-molding including a co-crystallized blend of a high density polyethylene (HDPE) base resin and a linear low density polyethylene (LLDPE). A method of producing a polyethylene-based resin composition includes adding the LLDPE to the HDPE base resin at a molten state to provide a blend of HDPE and LLDPE, wherein at the molten state, the LLDPE is fully miscible with the HDPE base resin and co-crystallizing the blend of HDPE and LLDPE.

### BACKGROUND

Hollow articles, such as containers, are often produced by injection stretch blow molding (ISBM) thermoplastic polymers. ISBM generally includes two steps: injection molding a polymer to provide a preform, followed by stretch-blowing of the preform to provide an expanded article. ISBM may be performed as either a single-stage process, where the preform production and stretch-blowing is performed by the same machine, or a two-stage process where each step is performed separately. ISBM is widely used because it allows for the efficient, high-volume production of articles.

Polyethylene is a common packaging material due to its unique combination of desirable physical properties and low cost. Despite this, polyethylene resins are rarely used in ISBM processes. Instead, polyethylene articles are generally produced through extrusion blow molding, a process that disadvantageously generates a regrind. Accordingly, there exists a need for polyethylene resins for use in ISBM processes that are suitable for the production of polyethylene containers.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a polyethylene-based resin composition for injection stretch blow-molding including a co-crystallized blend of a high density polyethylene (HDPE) base resin and a linear low density polyethylene (LLDPE).

In another aspect, embodiments disclosed herein relate to a method of producing a polyethylene-based resin composition. The method includes adding the LLDPE to the HDPE base resin at a molten state to provide a blend of HDPE and LLDPE, wherein at the molten state, the LLDPE is fully miscible with the HDPE base resin and co-crystallizing the blend of HDPE and LLDPE.

Other aspects and advantages of the claimed subject matter will be apparent from the following description and the appended claims.

### BRIEF DESCRIPTION OF DRAWINGS

FIG. 1 depicts a graph of melt peaks of co-crystallized blends in accordance with one or more embodiments of the present disclosure.

FIG. 2 depicts a graph of melt peaks of co-crystallized blends in accordance with one or more embodiments of the present disclosure.

FIG. 3 depicts a graph of integrated peak areas of melt peaks of co-crystallized blends in accordance with one or more embodiments of the present disclosure.

FIG. 4 depicts a graph of stiffness of co-crystallized blends in accordance with one or more embodiments of the present disclosure.

FIG. 5 depicts a graph of stiffness of co-crystallized blends in accordance with one or more embodiments of the present disclosure.

FIG. 6 depicts a graph of the melt peak curve of co-crystallized blends in accordance with one or more embodiments of the present disclosure.

FIG. 7 depicts a graph of Dynamic Mechanical Analysis (DMA) of co-crystallized blends in accordance with one or more embodiments of the present disclosure.

FIGS. 8A-B, 9A-B, 10A-B, 11A-B, 12A-B and 13A-B show the image results of Atomic Force Microscopy (AFM) of co-crystallized blends in accordance with one or more embodiments of the present disclosure.

FIGS. 14A-B show the image results of Atomic Force Microscopy (AFM) in 5 μm amplitude modulation mode (or tapping mode) of a co-crystallized blend in accordance with one or more embodiments of the present disclosure and a comparative HDPE base resin.

FIGS. 15A-B depict graphs of lamellar thickness as a function of blend % and type of co-crystallized blends using the Gibbs-Thompson equation, in accordance with one or more embodiments of the present disclosure.

FIG. 16 shows an image of polyethylene bottle preforms and indicates the transversal cut of the wall that were trimmed in a trapezoidal shape.

### DETAILED DESCRIPTION

Embodiments disclosed herein relate to polyethylene-based composition for injection stretch blow-molding applications, methods of producing such compositions, methods of forming injection stretch blow-molding articles from such compositions, and the resulting articles.

In a stretch-molding step of an ISBM process, a preform, formed in the injection molding step, is reheated to the glass transition temperature of the resin and then stretch-blown into the desired article. Typically, preforms are reheated using infrared heaters. During reheating, it is important to maintain a uniform temperature throughout the preform, i.e., the internal temperature and external temperature of the preform should be the same or sufficiently similar. Additionally, the geometry and partial stiffness of the preform should be maintained so as to prevent any sagging or folding before stretch-blowing. Consistent stretch-blow processing of a given resin may only be achieved in a specific stretch-blow temperature window, where the preform has a uniform, or similar, temperature throughout, and maintains its geometry and partial stiffness. Accordingly, the stretch-blow temperature window, also referred to herein as the processing window, of a given thermoplastic resin may restrict its use in ISBM processes.

High density polyethylene (HDPE) is primarily made up of unsaturated carbon-carbon bonds, making it less efficient at absorbing the radiation emitted by the infrared heaters in an ISBM oven. On top of low heat absorption, HDPE resins exhibit low heat conductivity and high heat capacity compared to thermoplastic resins that undergo ISBM more readily. Thus, the stretch-blow temperature window of HDPE resins is quite narrow. To achieve uniform internal and external heating, HDPE preforms typically spend more time under heat exposure, with lower cycle times, at a higher energy (i.e., higher lamp power output), which often results in a greater scrap rate.

Thus, the present disclosure relates to polyethylene-based resin compositions for use in ISBM processes, and methods of preparation thereof. In one or more embodiments, polyethylene-based resin compositions include an HDPE base resin and an additive. The additive may be a linear low-density polyethylene (LLDPE) resin. Disclosed compositions may exhibit modified crystallinity and a broader stretch-blow temperature window as compared to HDPE, alone. Methods of preparing polyethylene-based resin compositions may include co-crystallization of the HDPE base resin and the LLDPE. Such co-crystallization may be responsible for imparting the disclosed compositions with desirable mechanical and rheological properties.

### Polyethylene-Based Resin Composition

In one aspect, embodiments disclosed herein relate to a polyethylene-based resin composition comprising a co-crystallized blend of an HDPE base resin and an additive. The additive may be an LLDPE resin. The HDPE base resin may be any polyethylene base resin having a density ranging from 0.946 to 0.970 g/cm³.

In one or more embodiments, the HDPE base resin is included in the co-crystallized blend in an amount ranging from 90 to 99 wt. %, based on the total weight of the blend. For example, the co-crystallized blend may include an HDPE base resin in an amount ranging from a lower limit of any of 90, 91, 92, 93, 94, and 95 wt. % to an upper limit of any of 95, 96, 97, 98, and 99 wt. %, where any lower limit may be paired with any mathematically compatible upper limit. In particular embodiments, the HDPE may be present in the co-crystallized blend in an amount of 95 wt. %, based on the total weight of the blend.

In one or more embodiments, the co-crystallized blend includes an additive, which may be an LLDPE resin. As will be appreciated by one of ordinary skill in the art, LLDPE resins may be prepared using a Ziegler Natta catalyst or a metallocene catalyst, to provide a ZN-LLDPE resin or an mLLDPE resin, respectively. In one or more embodiments, the LLDPE resin included in the co-crystallized blend is an mLLDPE resin.

In one or more embodiments, the LLDPE resin is included in the co-crystallized blend in an amount ranging from 1.0 to 10 wt. % (weight percent), based on the total weight of the blend. For example, the co-crystallized blend may include LLDPE in an amount ranging from a lower limit of any of 1.0, 1.5, 2.0, 3.0, 4.0, and 5.0 wt. % to an upper limit of any of 5.0, 6.0, 7.0, 8.0, 9.0, and 10 wt. %, where any lower limit may be paired with any mathematically compatible upper limit. In particular embodiments, the LLDPE may be present in the co-crystallized blend in an amount of 5 wt. %, based on the total weight of the blend.

Embodiment LLDPE resins may have short chain branching (SCB) of a comonomer that is included in the preparation of the resin. Variables such as the degree of SCB and the identity of the comonomer can affect the crystallinity, resistance, and processability of the LLDPE resin, and therefore, can affect the same properties of the co-crystallized blend. In one or more embodiments, the comonomer may be an «-olefin. Suitable comonomers include, but are not limited to, propene, 1-butene, 1-hexene, 1-octene, norbornene, and combinations thereof. In particular embodiments, the comonomer may be 1-hexene.

The comonomer may be included in an LLDPE resin in an amount ranging from 2.5 to 10 wt. %, based on the total weight of the resin. For example, in one or more embodiments the LLDPE resin includes a comonomer in an amount ranging from a lower limit of any of 2.5, 3.0, 4.0, and 5.0 wt. % to an upper limit of any of 6.0, 7.0, 8.0, 9.0, and 10 wt. %, where any lower limit may be paired with any mathematically compatible upper limit. In particular embodiments, the comonomer is present in the LLDPE resin in an amount ranging from 5.0 to 10 wt. %, based on the total weight of the resin. The distribution of the comonomer within the LLDPE can be determined using a gel permeation chromatography— infrared GPC-IR instrument such as a GPC-IR5.

Polyethylene-based resin compositions in accordance with the present disclosure may optionally further comprise one or more additives that modify various physical and/or chemical properties of the composition. Such additives may be selected from, for example, flow lubricants, antistatic agents, clarifying agents, nucleating agents, beta-nucleating agents, slippage agents, antioxidants, antacids, light stabilizers, IR absorbers, silica, titanium dioxide, organic dyes, organic pigments, inorganic dyes, inorganic pigments, and combinations thereof. One of ordinary skill in the art will appreciate, with the benefit of this disclosure, that the choice of additive may be dependent upon the intended use of the composition and/or articles produced therefrom. It will also be appreciated that such additives are not limited to those described above.

As described above, co-crystallized blends of the present disclosure include an HDPE base resin and LLDPE. Herein, a “co-crystallized blend” is a blend made of polymeric resins that have been crystallized together such that the two polymers are entangled in a solid state. As is known in the art, LLDPE and HDPE are generally only partially miscible. Accordingly, various properties of the HDPE and LLDPE resins may be tailored so as to achieve more complete miscibility of the two resins and successfully produce a co-crystallized blend in the solid state. For example, an LLDPE having a similar viscosity to the HDPE base resin may exhibit greater miscibility, thus leading to better co-crystallization. Additionally, a lower molecular weight LLDPE may also exhibit greater miscibility with an HDPE base resin, due to a more facile diffusion.

Accordingly, in one or more embodiments, the LLDPE resin of a co-crystallized blend may be selected based, in part, on its melt flow index (MFI). For example, the LLDPE resin included in a co-crystallized blend may have an MFI measured according to ASTM D1238 at 190° C. under a 2.16 kg load, of less than 2.0 g/10 min. In particular embodiments, the LLDPE resin may have an MFI of less than 2.0, less than 1.5, less than 1.0, less then 0.8, or less than 0.5 g/10 min.

In one or more embodiments, the HDPE resin of a co-crystallized blend may have an MFI measured according to ASTM D1238 at 190 under a 2.16 kg load, ranging from 1.0 to 3.0 g/10 min. For example, the MFI of an HDPE resin included in a co-crystallized blend may range from a lower limit of any of 1.0, 1.2, 1.4, 1.6, 1.8, and 2.0 g/10 min, to an upper limit of any of 2.0, 2.2, 2.4, 2.6, 2.8, and 3.0 g/10 min, where any lower limit may be paired with any mathematically compatible upper limit.

In one or more embodiments, the ratio of the MFI of an LLDPE to the MFI of an HDPE base resin in a co-crystallized blend is less than or equal to 1.0. In particular embodiments, the ratio of the MFI of the LLDPE to the MFI or the HDPE may be less than or equal to 0.8, less than or equal to 0.7, or less than or equal to 0.5.

Density of the resins is another variable that may contribute to the extent of entanglement between the HDPE and LLDPE, and thus, the resultant properties of the co-crystallized blend. In particular, the density of the LLDPE may play an important role in the crystallinity of the co-crystallized blend. In one or more embodiments, LLDPE resins included in polyethylene-based compositions disclosed herein may have a density ranging from 0.915 to 0.933 g/cm³, according to ASTM D792. For example, LLDPE resins may have a density ranging from a lower limit of any of 0.915, 0.917, 0.919, 0.921, 0.923, and 0.925 g/cm³ to an upper limit of any of 0.925, 0.927, 0.929, 0.931, and 0.933 g/cm³, where any lower limit may be paired with any mathematically compatible upper limit.

In one or more embodiments, the HDPE base resin included in polyethylene-based compositions has a density, according to ASTM D792 ranging from 0.946 to 0.970 g/cm³. For example, polyethylene-based compositions may include an HDPE resin having a density ranging from a lower limit of any of 0.946, 0.948, 0.950, 0.952, 0.954, and 0.956 g/cm³ to an upper limit of any of 0.958, 0.960, 0.962, 0.964, 0.966, 0.968, and 0.970 g/cm³, where any lower limit may be paired with any mathematically compatible upper limit.

As previously described, sufficient entanglement of the HDPE and LLDPE resins may result in a co-crystallized blend having mechanical and rheological properties desirable for use in ISBM processes. These properties may be due to a modified crystallinity of the co-crystallized blend, compared to an HDPE resin without LLDPE. The crystallinity of a resin is influenced by ordered polymeric units, or lamellae. Altering the thickness of the lamellae in a resin may alter the crystallinity of the resin. In general, HDPE has a high degree of crystallinity. In entangling an HDPE base resin with LLDPE, the ordered lamellae of the HDPE may be disrupted, resulting in a modified crystallinity.

In particular, co-crystallized blends may have a reduced lamellar thickness compared to an HDPE resin without LLDPE. In one or more embodiments, the lamellar thickness of the co-crystallized blend is determined by a lower and broader melting point. The lamellar thickness of the co-crystallized blend may be tailored by altering the identity and concentration of SCB comonomers on the LLDPE resin.

Co-crystallized blends having reduced lamellar thickness may provide polyethylene-based resin compositions that can undergo ISBM processes more readily while maintaining the desirable mechanical properties of an HDPE resin without LLDPE.

In one or more embodiments, disclosed polyethylene-based compositions may have a broader melt peak than a melt peak of an HDPE resin that does not include LLDPE. The melt peak curve may be determined by differential scanning calorimetry (DSC) thermal analysis, where a shift in enthalpy may be observed and measured, for instance, when the polyethylene-based composition undergoes a phase transition, such as melting, crystallization, and glass transition phases. Two-phase blends, or immiscible blends, may exhibit two discrete melt peaks that correspond to each distinct phase of the immiscible blend. In contrast, miscible blends, such as co-crystallized blends, may exhibit a broad melt peak due to the formation of a single phase from two resins having different melt temperatures. For example, co-crystallized blends in accordance with the present disclosure include LLDPE and HDPE. Since LLDPE has a lower melt temperature than HDPE, a broader melt peak may be observed when the two resins exist in a miscible, co-crystallized blend, as compared to the melt peak of an HDPE resin without LLDPE. In particular, polyethylene-based compositions of one or more embodiments may start melting at a lower temperature than an HDPE resin without LLDPE.

A broadened melt peak, along with other properties such as, for example, a fast cycle time, an improved ESCR, and a low temperature tan delta, may provide the disclosed polyethylene-based resins with a broad melt processing window. A broad melt processing window may be beneficial for using the disclosed resins in manufacturing processes, and in particular, in ISBM processes.

In one or more embodiments, polyethylene-based resin compositions have a decreased processing temperature compared to a processing temperature of an HDPE resin that does not include LLDPE. Accordingly, compositions in accordance with the present disclosure may have a processing temperature about 2 to 8° C. lower than pure HDPE compositions. For example, the processing temperature of compositions of one or more embodiments is lower than that of a pure HDPE resin by an amount ranging from a lower limit of one of 2, 3, 4, and 5° C. to an upper limit of one of 5, 6, 7, and 8° C., where any lower limit may be paired with any mathematically compatible upper limit.

In one or more embodiments, polyethylene-based resin compositions have an improved zero-shear viscosity compared to an HDPE resin that does not include LLDPE. For example, polyethylene-based compositions may have zero-shear viscosity that is 1.0 to 1.5 times the zero-shear viscosity of an HDPE resin without the LLDPE. In one or more embodiments, polyethylene-based resin compositions may have a zero-shear viscosity that is 1.0 to 1.4 times that of HDPE without LLDPE, 1.0 to 1.3 times that of HDPE without LLDPE, 1.0 to 1.2 times that of HDPE without LLDPE, 1.1 to 1.5 times that of HDPE without LLDPE, 1.2 to 1.5 times that of HDPE without LLDPE, 1.3 to 1.5 times that of HDPE without LLDPE, 1.1 to 1.3 times that of HDPE without LLDPE, or 1.2 to 1.4 times that of HDPE without LLDPE.

In one or more embodiments, polyethylene-based resin compositions have a similar stiffness in the solid state compared to an HDPE resin without LLDPE. For example, the stiffness of a polyethylene-based composition in the solid state disclosed herein may be within 10% of a stiffness of HDPE in a solid state without the LLDPE. In particular embodiments, the polyethylene-based composition has a stiffness within 10%, within 8%, within 5%, within 3%, or within 1% of HDPE without LLDPE.

In one or more embodiments, polyethylene-based resin compositions have a similar yield point in the solid state compared to a solid HDPE resin that does not include LLDPE. For example, polyethylene-based compositions in the solid state may have a yield point within 5% of a yield point of a solid HDPE resin without the LLDPE. In particular embodiments, the polyethylene-based composition has a yield point within 5%, within 4%, within 3%, within 2%, or within 1% of HDPE without LLDPE.

In one or more embodiments, polyethylene-based resins have a different crystalline morphology than an HDPE resin that does not include LLDPE. As described above, this difference may be exemplified by the reduced lamellar thickness of the co-crystallized blend.

In one or more embodiments, the polyethylene-based resin composition is characterized as a co-crystallized blend using an analytical technique known in the art. Suitable analytical techniques for identifying the co-crystallized blend as such include environmental stress crack resistance (ESCR), differential scanning calorimetry (DSC), temperature rising elution fractionation (TREF), x-ray diffraction (XRD), and combinations thereof.

### Method of Preparing Polyethylene-Based Compositions

In another aspect, embodiments of the present disclosure relate to methods of preparing the polyethylene-based resin compositions as previously described. Each resin in the co-crystallized blend of polyethylene-based resin compositions may be prepared separately. The HDPE resin of the co-crystallized blend may be prepared according to any suitable method known in the art. In particular embodiments, the HDPE blend may be prepared using a Zeigler Natta catalyst. The LLDPE resin of the co-crystallized blend may be prepared according to any suitable method known in the art. In one or more embodiments, preparation of the LLDPE includes a metallocene catalyst and a comonomer.

In one or more embodiments, an LLDPE is added to an HDPE base resin at a molten state to provide a blend of HDPE and LLDPE. At the molten state, the LLDPE may be fully miscible with the HDPE. The HPDE base resin and LLDPE may reach a molten state at a temperature ranging from 125 to 135° C. For example, a molten state of the HDPE and LLDPE may be reached at a temperature ranging from a lower limit of one of 125, 126, 127, 128, 129, and 130° C. to an upper limit of one of 130, 131, 132, 133, 134, and 135° C., where any lower limit may be paired with any mathematically compatible upper limit.

After the HDPE and LLDPE have been mixed together at a molten state, one or more embodiment methods include co-crystallizing the blend of HDPE and LLDPE. Co-crystallization of the blend of HDPE and LLDPE may be carried out such that, in a solid state, the HDPE and LLDPE are entangled together. As described above, entanglement of the HDPE and LLDPE may be determined according to various analytical methods known in the art. In one or more embodiments, a reduced lamellar thickness may indicate sufficient entanglement of the HDPE and LLDPE.

The molten blend of HDPE and LLDPE may be co-crystallized according to any suitable crystallization technique known in the art. In one or more embodiments that blend is co-crystallized by a thermodynamic crystallization The blend may be cooled to a sufficient temperature to achieve co-crystallization. For example, in one or more embodiments, the co-crystallization of the blend may be carried out at a temperature ranging from 115 to 125° C. The blend may be co-crystallized at a temperature ranging from a lower limit of one of 115, 116, 117, 118, 119, and 120° C. to an upper limit of one of 120, 121, 122, 123, 124, and 125° C., where any lower limit may be paired with any mathematically compatible upper limit.

As previously described, the co-crystallized blend of HDPE and LLDPE may be characterized as such using an analytical technique known in the art. Suitable techniques for determining the co-crystallized blend include environmental stress crack resistance (ESCR), differential scanning calorimetry (DSC), temperature rising elution fractionation (TREF), x-ray diffraction (XRD), and combinations thereof.

Method of Preparing Articles from Polyethylene-Based Compositions

In one or more embodiments, polyethylene-based resin compositions in accordance with the present disclosure are used in injection stretch blow molding (ISBM) processes to produce articles from the co-crystallized blend of HDPE and LLDPE.

The ISBM process of one or more embodiments may include at least an injection molding step and a stretch-blowing step. In the injection molding step, a polyethylene-based resin composition is injection molded to provide a preform. In the stretch-blowing step the preform is heated, stretched, and expanded through the application of pressurized gas to provide an article. The two steps may, in some embodiments, be performed on the same machine in a one-stage process. In other embodiments, the two steps may be performed separately in multiple stages.

The ISBM processes in accordance with one or more embodiments of the present disclosure may include an injection-molding step that involves injecting a resin composition into a cavity of a mold. The injection-molding step provides a preform, which may have an open end and a closed end. The open end may correspond to a bottleneck. Processes in accordance with one or more embodiments of the present disclosure may include extruding a polyethylene-based resin composition, plasticizing the extruded composition, and injecting the composition, under pressure, into an injection mold.

One of ordinary skill will appreciate that the injection temperature will depend upon the physical properties of the composition, to some degree. In some embodiments, the injecting may be performed at a temperature that is lower than typically found in the art. In particular embodiments, the injection of the resin composition is performed at a process temperature ranging from 170° C. to 220° C. In some embodiments, the injecting may have a process temperature ranging from a lower limit of 150, 155, 160, 165, 170,175 or 180° C. to an upper limit of 175, 180, 185, 190, 195, 200, 210 or 220° C., where any lower limit can be used in combination with any upper limit.

The mold of one or more embodiments of the present disclosure is not particularly limited and may be any suitable mold known to one of ordinary skill in the art. In some embodiments, the mold may be a multi-cavity mold. In some embodiments, the resin composition may be injected into only one cavity of the mold, while, in other embodiments, the resin composition may be injected into more than one cavity of the mold.

Moreover, it is envisioned that the injection molding parameters used in the injection strech blow molding process are not particularly limited and may be set according to the common knowledge of one of ordinary skill in the art as it is appreciated that the resin composition, after formation of a preform will undergo another thermal cycle during reheating of the preform.

For example, the injecting process in accordance with the present disclosure may have an injection speed ranging from about 250 to 300 mm/s. In some embodiments, the injecting may have an injection speed ranging from a lower limit of any of 250, 255, 260, 265, 270, and 275 mm/s to an upper limit of any of 275, 280, 285, 290, 295 and 300 mm/s, where any lower limit may be paired with any mathematically compatible upper limit.

The injecting process in accordance with the present disclosure may have an injection flow rate ranging from about 8 to 60 cm³/s in each cavity. In some embodiments, the injecting may have an injection flow rate ranging from a lower limit of any of 8, 20, 15, 20, 30, and 35 cm³/s to an upper limit of any of 30, 40, 50, and 60 cm³/s, where any lower limit may be paired with any mathematically compatible upper limit. The injecting process in accordance with the present disclosure may have a preform hold pressure in each cavity time ranging from about 2 to 20 s. In some embodiments, the injecting may have a preform hold pressure time ranging from a lower limit of any of 2, 3, 4, 5, 8 and 10 s to an upper limit of any of 11, 12, 13, 14, 15, 18 and 20 s, where any lower limit may be paired with any mathematically compatible upper limit.

In one or more embodiments, the injecting may have an average injection pressure in each cavity ranging from about 200 to 800 bar. For example, the injecting may have an average injection pressure ranging from a lower limit of any of 200, 250, 300, 325, 330, 335, 340, and 350 bar, to an upper limit of any of 450, 550, 600, 700, 750, and 800 bar, where any lower limit may be paired with any mathematically compatible upper limit.

In one or more embodiments, the injecting may have a cooling period of the preform retained in the mold from about 4 to 25 s. For example, the injecting may have cooling period of the preform retained on the mold ranging from a lower limit of any of 4, 5, 6, 8, and 10 s, to an upper limit of any of 11, 12, 14, 15, 20 and 25 s, where any lower limit may be paired with any mathematically compatible upper limit.

In one or more embodiments, the injecting may have a cooling temperature in the mold release from about 5 to 40° C. For example, the injecting may have a cooling temperature in the mold release ranging from a lower limit of any of 5, 10, 15, and 20° C., to an upper limit of any of 25, 30, 35 and 40° C., where any lower limit may be paired with any mathematically compatible upper limit.

In one or more embodiments, the injecting may have a total molding cycle time from about 15 to 40 s. For example, the injecting may have a total molding cycle time ranging from a lower limit of any of 15, 17, 20, 22 and 25 s, to an upper limit of any of 20, 25, 30, 35, and 40 s, where any lower limit may be paired with any mathematically compatible upper limit.

In one or more embodiments, the injecting may have a total molding cycle time from about 10 to 40 s. For example, the injecting may have a total molding cycle time ranging from a lower limit of any of 10, 15, 17, 20, 22 and 25 s, to an upper limit of any of 20, 25, 30, 35, and 40 s, where any lower limit may be paired with any mathematically compatible upper limit.

In one or more embodiments, the preform obtained from the injection molding process may have a wall thickness from about 1.5 to 4.0 mm. For example, the preform obtained from the injection molding process may have a wall thickness ranging from a lower limit of any of 1.5, 1.6, 1.7, 1.8, 1.9 and 2.0 mm, to an upper limit of any of 2.5, 2.7, 3.0, 2.5 or 4.0 mm, where any lower limit may be paired with any mathematically compatible upper limit.

In one or more embodiments, the injecting may have a pressing pressure of about 300 bar. In some embodiments, the injecting may have a pressing pressure ranging from a lower limit of any of 280, 290, and 300 bar, to an upper limit of any of 300, 310, and 320 bar, where any lower limit may be paired with any mathematically compatible upper limit.

In a multi-stage ISBM process in accordance with one or more embodiments of the present disclosure, the preform may be cooled to room temperature and transported to a stretch-blowing machine. In such embodiments, the preform is reheated on the stretch-blowing machine. In a single-stage ISBM process in accordance with one or more embodiments of the present disclosure, the preform may be heated prior to stretch-blowing.

In the stretch-molding step of one or more embodiments, the preform may be positioned with the bottleneck facing downwards. The ISMB process of one or more embodiments may include stretching the preform with a stretch rod. The stretching may be performed in an axial direction. The stretching of one or more embodiments may have a stretch rod speed ranging from 500 to 1500 mm/s. For example, the stretching may have a stretch rod speed ranging from a lower limit of any of 500, 600, 700, 800, 900, and 1000 mm/s, to an upper limit of any of 800, 900, 1000, 1100, 1200 and 1500 mm/s, where any lower limit may be paired with any mathematically compatible upper limit.

The temperature of the preform prior to the stretching in one or more embodiments may range from about 90 to 140° C. For example, the temperature of the preform may range from a lower limit of any of 90, 105, 107, 110 and 113° C., to an upper limit of any of 115, 117, 118, 120, 130 and 140° C., where any lower limit may be paired with any mathematically compatible upper limit.

In some embodiments, the stretched preform is radially blown by pressurized gas. Radial blowing may be done using gas with a pressure ranging from 10 to 20 bar. For example, the pressurized gas may have a pressure ranging from a lower limit of any of 10, 12, 14, and 15 bar, to an upper limit of any of 15, 16, 18, and 20 bar, where any lower limit may be paired with any mathematically compatible upper limit.

In the stretch-molding step of one or more embodiments, the preform may be blown in two or more stages. In some embodiments, the stretch-blowing includes a first stage and a second stage, wherein the first stage uses gas of a lower pressure than the second stage. In particular embodiments, the first stage includes blowing gas having a pressure ranging from about 2 to 10 bar, or from about 2 to 8 bar, and the second stage may comprise blowing gas having a pressure ranging from about 10 to 20 bar.

In the stretch-molding step of one or more embodiments, the process may have an axial stretch ratio ranging from about 1.5 to 2.0, a hoop stretch ration ranging from about 2 to 4, and an overall stretch ratio ranging from 3.0 to 10.

Processes in accordance with one or more embodiments may provide at least a yield of 500 articles/hour. In particular embodiments, methods in accordance with the present disclosure may yield 600 to 700 articles/hour on a cavity-equipped Pavan Zanetti Bimatic 4000 machine, where the articles are cylindrical bottles.

### Articles

As will be apparent to one of ordinary skill in the art having the benefit of the present disclosure, articles may be formed from any of the above-mentioned polyethylene-based resin compositions or ISBM processes. The articles in accordance with some embodiments of the present invention may be hollow articles and, in particular embodiments, may be bottles. In some embodiments, the articles may be used for various food packaging applications, such as for water bottles. In other embodiments, the articles may be used for packaging cleaning products such as for detergent bottles.

Articles in accordance with one or more embodiments of the present invention may have a volume ranging from 500 to 3000 cm³, more specifically between 900 and 1200 cm³. In some embodiments, the articles may have a weight ranging from about 18 to 40 grams per article or from about 24 to 32 grams per article.

### EXAMPLES

The following examples are merely illustrative and should not be interpreted as limiting the scope of the present disclosure.

Exemplary LLDPE resins 1-3 and a cyclic olefin copolymer (COC) were prepared with the properties provided in Table 1, below.

TABLE 1
Properties of LLDPE resins 1-3 and COC.

| Properties | LLDPE 1 | LLDPE 2 | LLDPE 3 | COC |
|---|---|---|---|---|
| Catalyst | Metallocene | Metallocene | Metallocene | — |
| Identity | 1 | 1 | 2 | |
| MFI (190° C./ | 1.0 | 3.5 | 1.0 | 1.8 |
| 2.16 kg, g/ | | | | |
| 10 min) | | | | |
| Density | 0.917 | 0.918 | 0.933 | 1.01 |
| (g/cm³) | | | | |
| Comonomer | 1-hexene | 1-hexene | 1-hexene | 1-hexene |
| Mw/Mz | </=3 | </=3 | 3-4 | </=3 |
| LCB | No | No | No | No |

Various HDPE base resins were prepared, the polymerization process and properties of which are shown in Table 2.

TABLE 2
Properties of HDPE resins

| Properties | HDPE 1 | HDPE 2 | HDPE 3 | HDPE 4 |
|---|---|---|---|---|
| Polymerization | Slurry | Gas Phase | Slurry | Gas Phase |
| Process | | | | |
| Technology | Hostalen | Spherilene | Hostalen | Unipol |
| Modality | Bimodal | Monomodal | Bimodal | Monomodal |
| Catalyst Type | ZN | ZN | ZN | ZN |
| MFI (190° C./ | 2.0 | 1.0 | 0.75-0.78 | 0.3 |
| 2.16 kg, g/10 min) | | | | |
| Density (g/cm³) | 0.952 | 0.948 | 0.953-0.956 | 0.954 |
| Comonomer | butene | butene | butene | hexene |

Co-crystallized blends were prepared by mixing one of HDPE resins 1-4 with one of LLDPE resins 1-3 and COC 1 at a molten state, and then co-crystallizing the blends to provide a resin in which the HDPE and LLDPE were entangled, performed in a Rulli Single Screw Extruder. Co-crystallized blends were prepared with either 5% or 10% loading of LLDPE. Table 3 shows the components of the exemplary and comparative blends.

TABLE 3
Composition of Co-crystallized Blends

| | HDPE 1 | HDPE 2 | LLDPE 1 | LLDPE 2 | LLDPE 3 | |
|---|---|---|---|---|---|---|
| | GE | HE | 9200 | 7200 | 3310 | COC |
| Sample 1 | 95% | | 5% | | | |
| Sample 2 | 95% | | | 5% | | |
| Sample 3 | 95% | | | | 5% | |
| Sample 4 | 90% | | 10% | | | |
| Sample 5 | 90% | | | 10% | | |
| Sample 6 | 90% | | | | 10% | |
| Sample 7 | 90% | | | | | 10% |
| Sample 8 | | 95% | 5% | | | |
| Sample 9 | | 95% | | 5% | | |
| Sample 10 | | 95% | | | 5% | |
| Sample 11 | | 90% | 10% | | | |
| Sample 12 | | 90% | | 10% | | |
| Sample 13 | | 90% | | | 10% | |

All samples were processed in a Rulli single screw extruder according to the parameters shown in Table 4.

TABLE 4
Extrusion Parameters

| Zone | Temperature | | Equipment | Rulli Gala | |
|---|---|---|---|---|---|
| 1 | 110° | C. | Die Holes | 12 | |
| 2 | 150° | C. | Screw Profile | Single-screw | |
| 3 | 180° | C. | Screw Rotation | 40 | rpm |
| 4 | 190° | C. | Amp./Torque | 83 | A/% |
| 5 | 190° | C. | Pelletizer Rotation | 2500 | rpm |
| 6 | 200° | C. | Mass Pressure | 84 | rpm |
| 7 | — | | Die Filters | 40/60/40 | mesh |
| Junction | 200° | C. | Water Temperature | 65° | C. |
| Die | 210° | C. | N₂ Use | Yes | |
| Melt | 222-244° | C. | Productivity | 65-84 | kg/h |

The properties of exemplary co-crystallized blends are shown below in Table 5.

TABLE 5
Properties of Exemplary Co-crystallized blends

| Properties | Sample 1 | Sample 4 | HDPE 1 |
|---|---|---|---|
| MFI 2.16 kg/190° C. | 1.9 | 1.8 | 2.0 |
| (g/10 min) | | | |
| Density (g/cm³) | 0.951 | 0.950 | 0.950 |
| Tc (° C.) | 118 | 117 | 118 |
| Tm (° C.) | 130 | 129 | 130 |
| Xc (%) | 69 | 66 | 71 |
| AH (W/g) | 199 | 189 | 204 |
| T 4% (° C.) | 98 | 95 | 101 |
| AT 4% (° C.) | 3.7 | 6.6 | 0.0 |
| T 22% (° C.) | 118 | 117 | 120 |
| AT 22% (° C.) | 2.0 | 3.2 | 0.0 |
| Flexural Modulus | 1113 | 1046 | 1175 |
| (MPa) | | | |
| Yield Strength | 25.2 | 24 | 24.8 |
| (MPa) | | | |
| Elongation at Yield | 9.7 | 9.9 | 9.7 |
| (%) | | | |
| Break Strength | 33.5 | 33.8 | 31.5 |
| (MPa) | | | |
| Elongation at | 2031 | 1948 | 1999 |
| Break (%) | | | |
| IZOD 23° C. (J/m) | 125 | 133 | 75 |
| FNCT 4 MPa/100% | 79 | 122 | 46 |
| MEG/80° C. (min) | | | |
| ESCR-B 10% | 24 | 26 | 15 |
| IGEPAL (hrs) | | | |

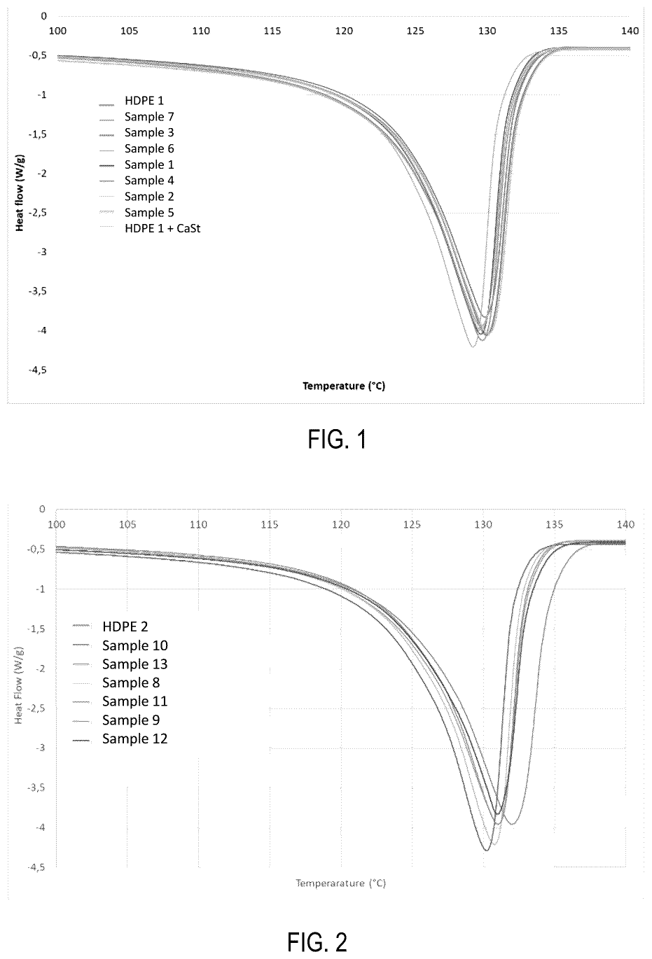

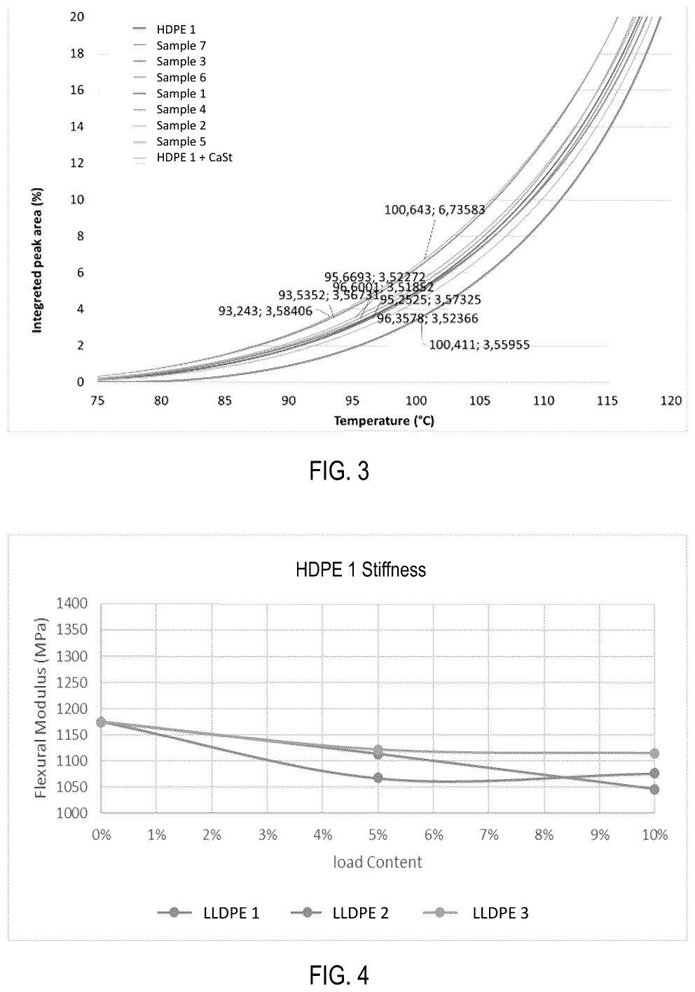

FIGS. 1 and 2 depict graphs of melt peaks of Samples 1-13 and HDPE 1 and HDPE 2, for comparison. A graph of the integrated peak areas of Samples 1-7 and HDPE 1 is provided in FIG. 3. In FIG. 3, it can be seen that each of the blends in Samples 1-7 successfully lowered the molten temperature of the HDPE base resin (HDPE 1).

FIG. 4 shows a graph of the stiffness of Samples 1-6 and base resin HDPE 1, measured as the flexural modulus (MPa). As can be seen in FIG. 4, the addition of LLDPE to the base HDPE resin does decrease the stiffness of the resin. However, the decrease is not linear to the loading of LLDPE in the case of LLDPE 2 and LLDPE 3. Notably, when LLDPE 2 is added to HDPE 1, the stiffness of the co-crystallized blend increases from a 5% loading to a 10% loading of the LLDPE.

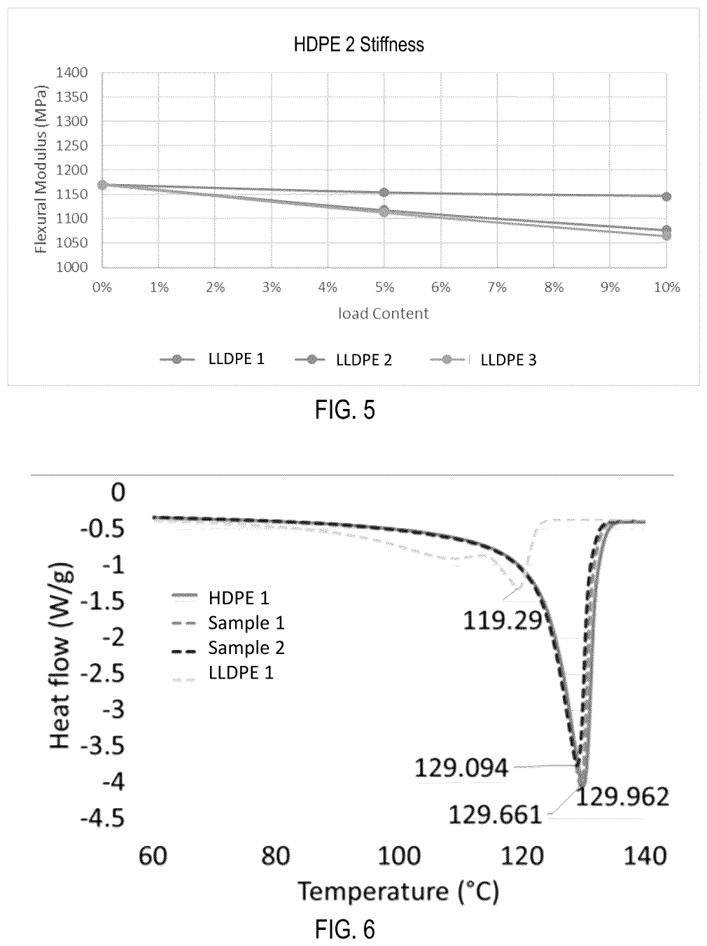

FIG. 5 shows a graph of the stiffness of Samples 8-13 and base resin HDPE 2, measured as the flexural modulus (MPa). The stiffness of HDPE 2 is even less altered than that of HDPE 1, but it also has a starting stiffness lower than HDPE 1. Addition of LLDPE 2, at both a 5% and 10% loading, barely alter the stiffness of the based HDPE resin, whereas the addition of LLDPE 1 and LLDPE 3 result in decreased stiffness to HDPE 2.

FIG. 6 shows a graph of the melt peak curve of HDPE1, Samples 1-2 and, LLDPE 1. The melt peak curve was determined by differential scanning calorimetry (DSC) thermal analysis, where a shift in enthalpy may be observed and measured, for instance, when the polyethylene-based composition undergoes a phase transition, such as melting, crystallization, and glass transition phases. The blends exhibited a single discrete melting peak and started melting at a lower temperature than an HDPE resin without LLDPE.

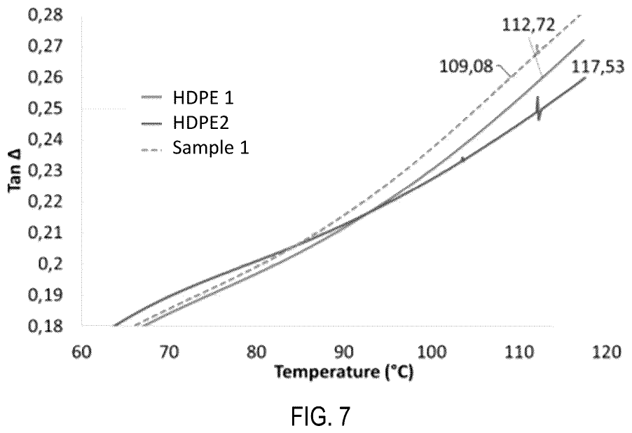

FIG. 7 show the graph of Dynamic Mechanical Analysis (DMA) for HDPE1, Samples 1-2 and, LLDPE 1. DMA technique evaluates the response of the material to deformation applied by a constant or oscillatory stress. Analyzes can be performed at constant or variable temperature/frequency. The described procedure makes it possible to determine glass transition region, degree of crystallinity, relaxation spectrum, cross-linking, phase separation, structural or morphological changes resulting from processing and chemical composition of polymeric blends, graphitized polymers and copolymers. Test samples were injection molded, with specimens being stamped out with the aid of a guillotine cutter, until the standard shape and size for DMA specimens can be obtained. The samples were analyzed in a DMA Q800, from TA Instruments, in single cantilever mode, which applies an oscillatory stress and doing a frequency sweep. The results show a difference in the damping (Tan A) of samples with and without LLDPE. The sample having LLDPE was able to achieve the same mobility of a sample without LLDPE at lower temperatures. For example, the sample having LLDPE achieved a Tan A value of 0.26 around 109° C., whereas the sample having HDPE only achieved the same Tan A value at approximately 113° C.

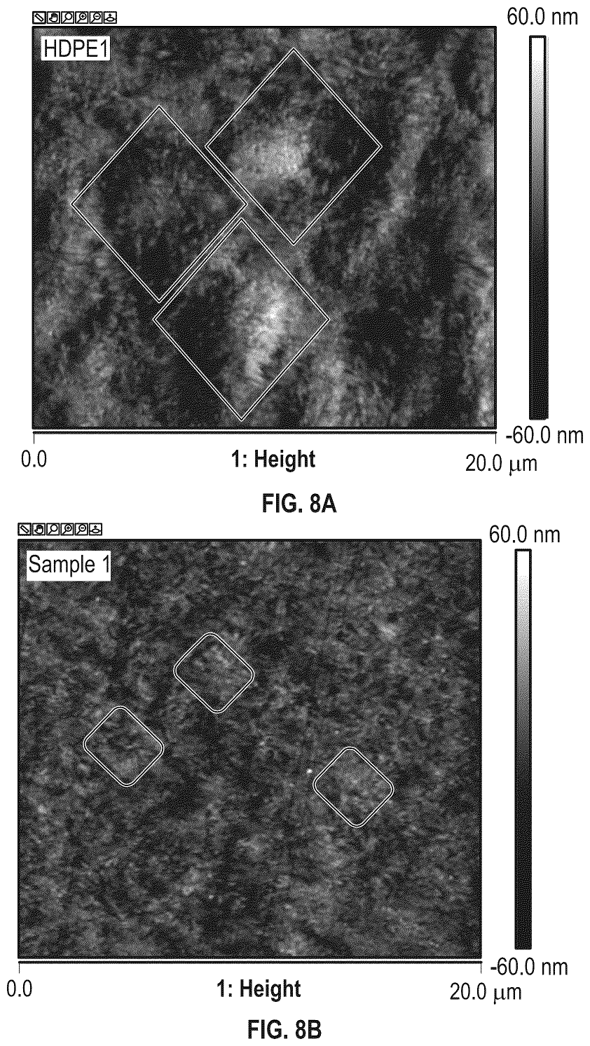

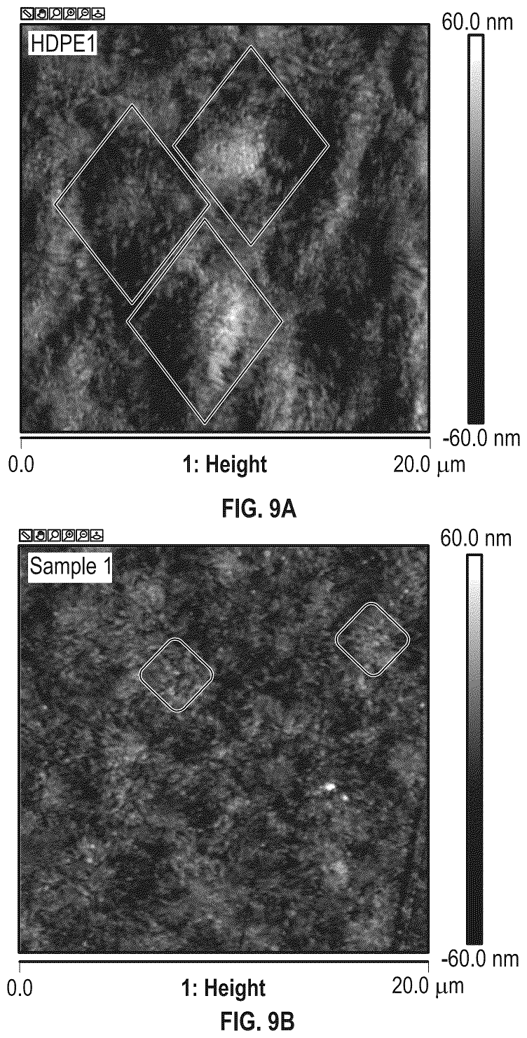

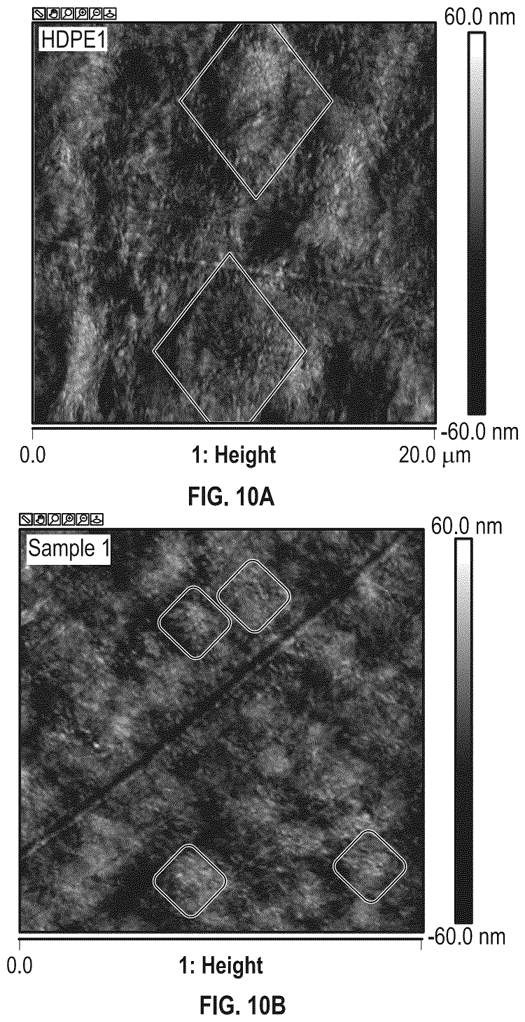

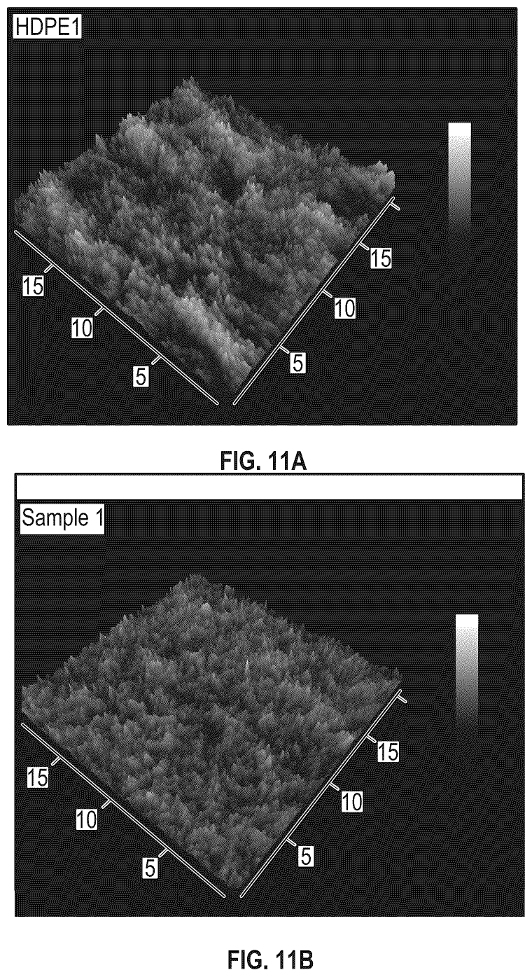

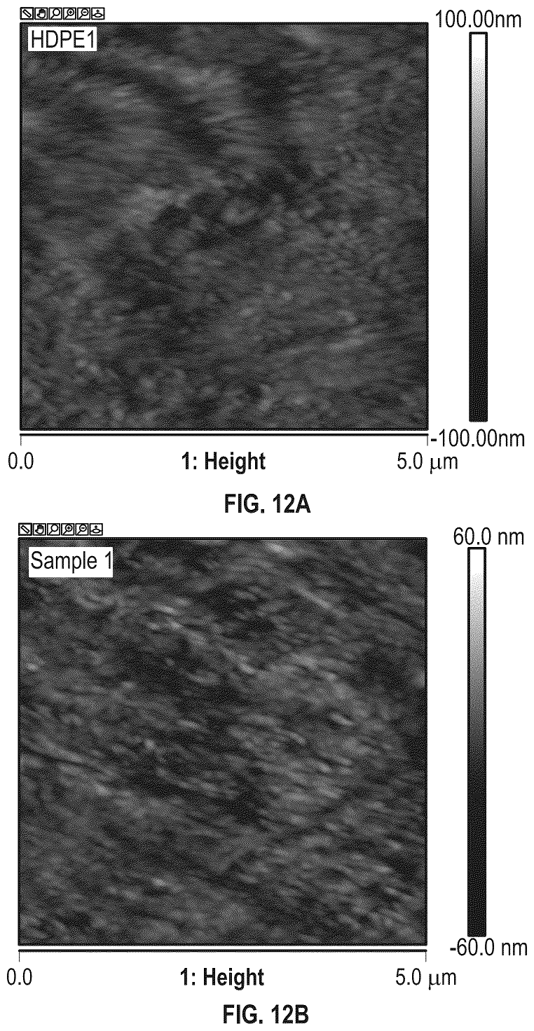

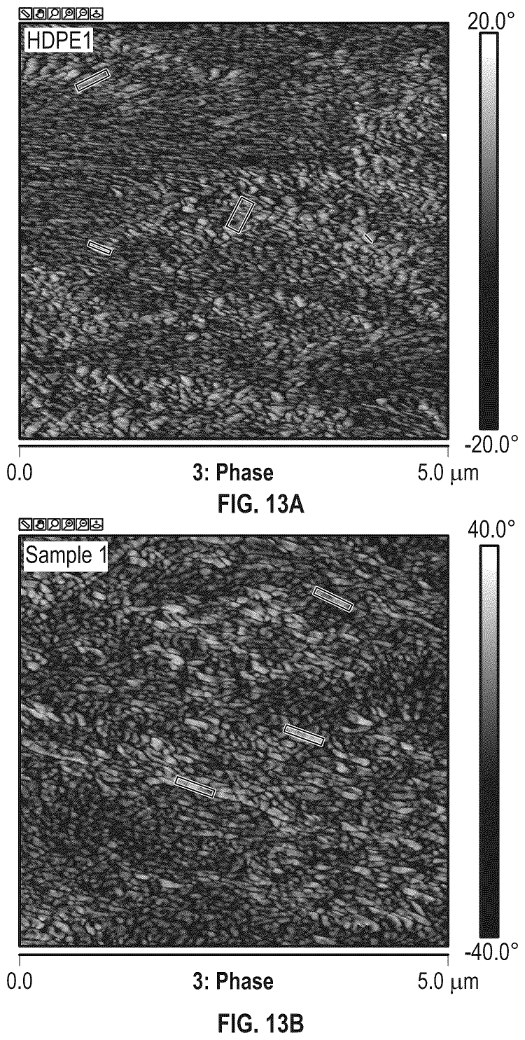

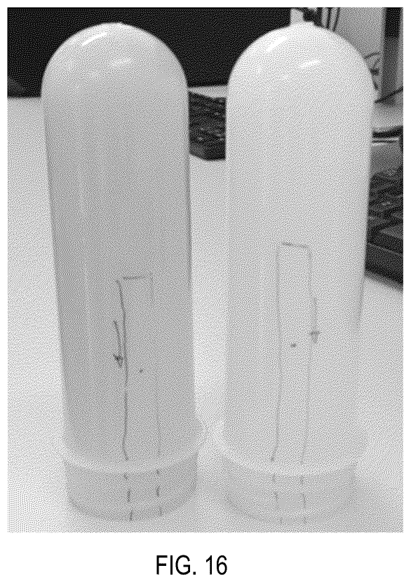

FIGS. 8A-B, 9A-B, 10A-B, 11A-B, 12A-B, 13A-B and 14A-B show the image results of Atomic Force Microscopy (AFM) of HDPE 1 and Sample 1, respectively. The test was performed in an AFM Nanoscope VIII—Bruker. The transversal cut of the wall of polyethylene bottle preform were trimmed in a trapezoidal shape, as per the indication in FIG. 16, and this region was cryo-ultramicrotomed at −120° C. using diamond knives of 45°. The tapping mode was select to perform these analyses. Antimony (n) doped Si probes (f0=320 KHz, K=42 N/m) were used to obtain the images. Images were acquired with scan size of 20 μm and 5 μm. The image generated with Height signal shows morphology/topography of the cryo-ultramicrotomed surface and phase signal shows differences of morphology/hardness of the samples structure. By comparing the image results for the HDPE1 with and without LLDPE1 (i.e., HDPE1 as compared to Sample 1), it is possible to see differences in supramolecular structures (size and shape of like-spherulites). FIGS. 11A-B shows that Sample 1 has a homogeneous morphology with edges smoother and its supramolecular structures (like spherulite) less than HDPE1 sample.

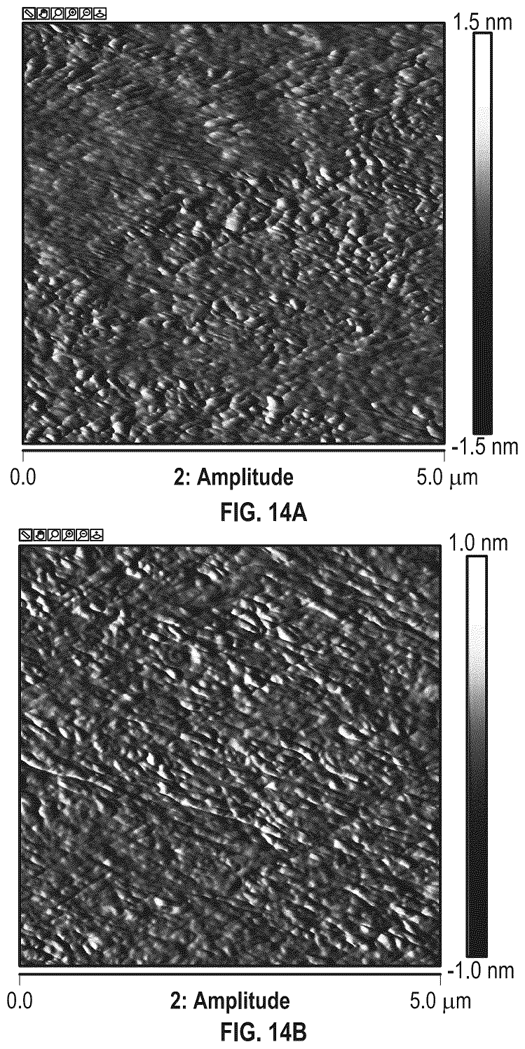

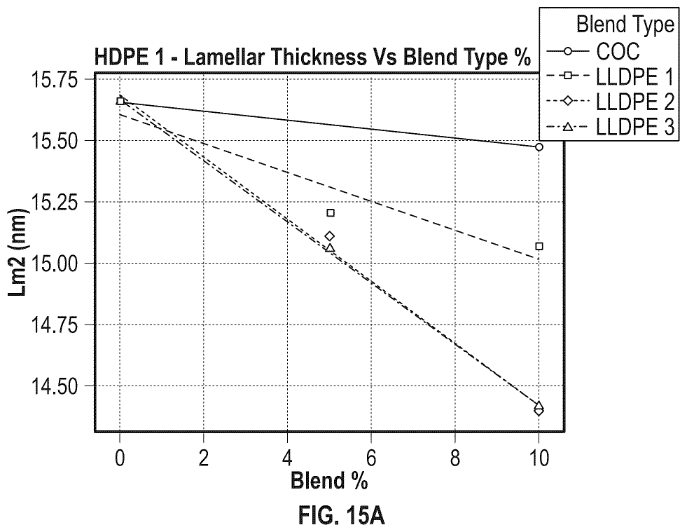

In FIG. 14A-B, it is also possible to observe smaller, more homogeneous crystallites and uniform crystal topography, with thinner lamella when compared to the HDPE base resin without the LLDPE.

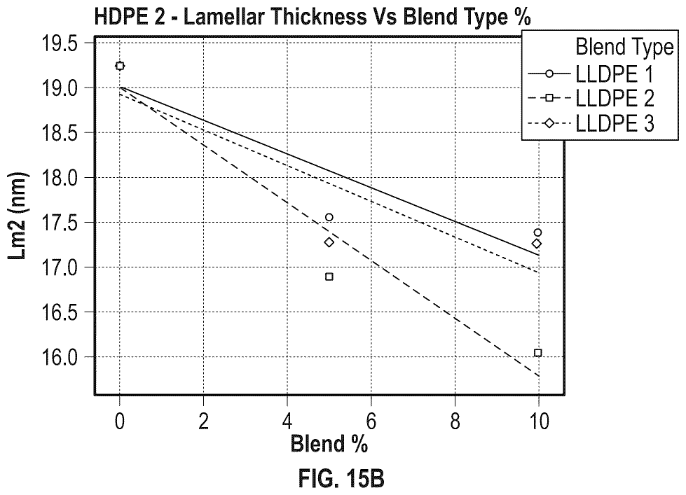

In FIGS. 15A and 15B, it is possible to note the lamellar thickness as a function of blend % and type of co-crystallized blends. Lamellar thickness was obtained using the Gibbs-Thompson equation, which allows for a DSC thermogram to be interpreted as statistical distribution of lamellar thicknesses. The melting points were determined by differential scanning calorimetry (DSC).

Water bottles were prepared in a two stage ISBM process using the exemplary compositions described above. Preforms for the ISBM process were molded in an Arburg Allrounder 520S 1600-400/170 injector. The basic injection parameters for the preforms are shown in Table 6.

TABLE 6
Preform Injection Molding Parameters
Process Temperatures (° C.)

| | | | | | | | |
|---|---|---|---|---|---|---|---|
| Zone 1 | Zone 2 | Zone 3 | Zone 4 | Nozzle | Mold | Fixed Side | 20 ± 2 |
| 190 | 195 | 200 | 205 | 210 | | Movable Side | 20 ± 2 |

| Mold Closing and Opening | | Injection and Packing | |
|---|---|---|---|
| Opening Course (mm) | 180 | Real Injection Pressure (bar) | 610 |
| Closing Force (kN) | 300 | Injection Velocity (cm³/s) | 14 |
| Opening Time (s) | 0.70 | Holding Pressure (bar) | 490 |
| Closing Time (s) | 2.50 | Injection Time (s) | 1.47 |
| | | Holding Time (s) | 10 |

| | |
|---|---|
| Dosing | Times |

| | | | |
|---|---|---|---|
| Screw Velocity (mm/s) | 180 | Pre-Extrusion Time (s) | — |
| Dosing Course (cm³) | 27 | Cooling Time (s) | 20 |
| Backpressure (bar) | 200 | Cycle Time (s) | 37.7 |
| Decompression Course (cm³) | 5 | Commutation Volume (cm³) | 11.5 |

The preforms were then stretch-blown in a Pavan Zanetti 3C/2L PETMATIC 4000 stretching blowing machine. Each preform required a specific set of stretch-blowing conditions. The SB process parameters for three preforms, Comparative Preform 1, Preform 1, and Preform 2 are shown below in Table 7.

TABLE 7
Stretch-blowing Process Parameters

| Parameters | Comp. Preform 1 | Preform 1 | Preform 2 |
|---|---|---|---|
| Blend Identity | HDPE 1 | Sample 1 | Sample 2 |
| Delayed Preblow Time (s) | 0.16 | 0.16 | 0.16 |
| Preblow Time (s) | 0.6 | 0.5 | 0.1 |
| Blow Time (s) | 2.0 | 2.0 | 1.5 |
| Conveyor Time (s) | 6 | 5.5 | 5.5 |
| Oven Temperature (° C.) | 196 | 200 | 197 |
| Preblow Pressure (bar) | 4 | 6 | 4 |
| Blow Pressure (bar) | 10 | 10 | 10 |
| Stretching Rod | 1,000 | 1,600 | 1,600 |
| Velocity (mm/s) | | | |
| Exhaustion Velocity | 100 | 100 | 100 |
| (mm/s) | | | |

The ISBM properties of each preform are provided below in Table 8.

TABLE 8
Stretch-blowing Process Parameters

| Properties | Comp. Preform 1 | Preform 1 | Preform 2 |
|---|---|---|---|
| Cycle Time (s) | 6 | 5.5 | 5.5 |
| Productivity (bph) | 600 | 654 | 654 |
| Scrap Rate | 11% | 0% | 45% |
| PF weight (g) | 30.7 | 30.5 | 30.6 |
| Oven Temperature (° C.) | 196 | 196 | 197 |
| Internal Temperature (° C.) | 92.8 | 93.9 | 93.4 |
| Avg. External | 98.5 | 100.2 | 99.9 |
| Temperature (° C.) | | | |
| AT (° C.) | 5.7 | 6.3 | 6.5 |
| Maximum Load (N) | 255 | 243 | 191 |
| Yield Strength (MPa) | 0.17 | 0.27 | 0.25 |
| Compression Top Load | 0.94 | 0.90 | 0.73 |
| (MPa) | | | |

Notably, the scrap rate, determined by the number of ruptured preforms, of Preform 1 was superior to the same of Comparative Preform 1 (HDPE 1 only). Additionally, Preform 1 showed a similar maximum load to Comparative Preform 1 and had a half second shorter cycle time than Comparative Preform 1. Further Preform 1 had a faster cycle time, and a broader melt peak (shown in FIG. 3) than the comparative example, which indicates a broader processing window. Thus, the exemplary preforms, specifically Preform 1, demonstrate the viability of disclosed co-crystallized blends for use in ISBM processes.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A polyethylene-based resin composition for injection stretch blow-molding comprising:
a co-crystallized blend of a high density polyethylene (HDPE) base resin and a linear low density polyethylene (LLDPE).

2. The composition of claim 1, wherein the LLDPE is a metallocene LLDPE (mLLDPE).

3. The composition of claim 2, wherein the mLLDPE further comprises a plurality of short chain branches of a comonomer.

4. The composition of claim 3, wherein the comonomer is selected from the group consisting of propene, 1-butene, 1-hexene, 1-octene, and norbornene.

5. The composition of claim 3, wherein the comonomer is 1-hexene.

6. The composition of claim 3, wherein the comonomer is present in the mLLDPE in an amount ranging from about 1.0 to 10% by weight.

7. The composition of claim 1, wherein the LLDPE is present in the co-crystallized blend in an amount of 1.0 to 10 wt % of the composition.

8. The composition of claim 1, wherein the LLDPE has a density, measured according to ASTM D792, ranging from 0.915 to 0.933 g/cm³ and/or a melt flow index (MFI), measured according to ASTM D 1238 at 190° C. under a 2.16 kg load, of less than 2.0 g/10 min.

9. The composition of claim 1, wherein the HDPE base resin has a density, measured according to ASTM D792, ranging from 0.946 to 0.970 g/cm³, and/or a melt flow index (MFI), measured according to ASTM D 1238 at 190° C. under a 2.16 kg load, ranging from 1.0 to 3.0 g/10 min.

10. The composition of claim 1, wherein a ratio of a melt flow index (MFI), as measured according to ASTM D 1238 at 190° C. under a 2.16 kg load, of the LLDPE to an MFI of the HDPE base resin is less than or equal to 1.

11. The composition of claim 1, wherein the LLDPE is fully miscible with the HDPE base resin in a molten state such that the LLDPE and the HDPE base resin exist as a single phase structure.

12. The composition of claim 1, wherein the co-crystallized blend has one or more of the following properties:
a reduced lamella thickness as compared to a lamella thickness of the HDPE base resin without the LLDPE;
a broader melt peak as compared to a melt peak of the HDPE base resin without the LLDPE, as measured by differential scanning calorimetry (DSC) thermal analysis;
a broader processing window as compared to a processing window of the HDPE base resin without the LLDPE;
a faster cycle time as compared to a cycle time of the HDPE base resin without the LLDPE;
a lower processing temperature as compared to a processing temperature of the HDPE base resin without the LLDPE;
a stiffness in a solid state within 10% of a stiffness of the HDPE base resin in a solid state without the LLDPE;
a yield point in a solid state within 5% of a yield point of the HDPE base resin without the LLDPE; and
a different crystalline morphology than the HDPE base resin without the LLDPE, based on a reduction in lamella thickness.

13. A method of producing the composition of claim 1, the method comprising:
adding the LLDPE to the HDPE base resin at a molten state to provide a blend of HDPE and LLDPE, wherein at the molten state, the LLDPE is fully miscible with the HDPE base resin; and
co-crystallizing the blend of HDPE and LLDPE.

14. The method of claim 13, wherein a zero shear viscosity of the LLDPE is within 1 to 1.5 times the zero shear viscosity of the HDPE base resin without the LLDPE.

15. An article comprising the composition of claim 1.

16. The article of claim 15, wherein the article is produced by injection stretch blow molding.

17. A method of producing an article, the method comprising:
injection molding the composition of claim 1 to give a preform; and
stretch-blowing the preform to provide the article.

18. The method of claim 17, wherein the injection molding comprises injecting the resin composition into at least one cavity of a mold, wherein optionally the injection of the resin composition is performed at a process temperature ranging from 170° C. to 220° C.

19. The method of claim 17, wherein the injecting has an injection flow rate in each cavity ranging from about 8 to 60 cm³/s and/or an injection pressure in each cavity ranging from about 200 to 800 bar.

20. The method of claim 17, wherein the preform comprises a bottleneck, and wherein the bottleneck is positioned to face downwards during the stretch-blowing.

21. The method of claim 17, wherein the stretch-blowing comprises stretching the preform with a stretch rod and the stretch rod has, optionally, a speed ranging from 500 to 1600 mm/s during the stretching of the preform.

22. The method of claim 17, wherein the stretch-blowing comprises blowing the preform with gas and, optionally, the gas has a pressure ranging from about 10 to 20 bar during the blowing.

23. The method of claim 17, wherein the stretch-blowing comprises blowing the preform with gas in two or more stages.

24. The method of claim 23, wherein the stretch-blowing comprises a first stage and a second stage, wherein the first stage uses gas of a lower pressure than the second stage, and optionally wherein the first stage comprises blowing gas having a pressure ranging from about 4 to 10 bar and the second stage comprises blowing gas having a pressure ranging from about 10 to 20 bar.

25. An article produced by the method of claim 17.

26. The article of claim 15, wherein the article is a hollow container.
